(19) United States
(12) Patent Application Publication
(10) Pub. No.: US 2006/0288312 A1
(43) Pub. Date: Dec. 21, 2006

(54) Information processing apparatus and recording medium storing program

(75) Inventors: Katsuhiko Akiyama, Kawasaki (JP); Hiroshi Tanaka, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/238,062

(22) Filed: Sep. 29, 2005

(30) Foreign Application Priority Data
Jun. 17, 2005 (JP) 2005-178278

(51) Int. Cl. G09G 5/08

(52) U.S. Cl. 715/856; 715/977; 715/837; 345/157

(57) ABSTRACT

An information processing apparatus includes a pointer symbol display portion for displaying a pointer symbol, a function executing portion for executing any of a plurality of functions, a selection symbol display portion for displaying selection symbols respectively representing the plurality of functions, a function selecting portion for detecting that any of the selection symbols is selected and changing the function to be executed by the function executing portion into the selected function, a selection symbol control portion for clearing a display of the selection symbol when the function selecting portion changes the function, and a pointer symbol control portion for changing the shape of the pointer symbol.

### BACKGROUND OF THE INVENTION

1. Field of the Invention

The present invention relates to an information processing apparatus or an information processing program that controls a selection symbol or a pointer symbol displayed on a screen of a display device based on an input from an input device.

2. Description of Related Art

In a GUI (Graphical User Interface) of an information processing apparatus, an interface is provided in which a predetermined function is selected by clicking a selection symbol (for example, an icon or the like) displayed on a screen with a pointer symbol such as a cursor. The cursor is operated using an input device such as a mouse or a stylus. In the above-noted GUI, a selecting function of selecting an object (for example, an icon, a character, a window, etc.) located at a position indicated by the cursor based on an input from an input device is provided. Besides the selecting function, a plurality of functions including a drawing function and an eraser function are provided as a function realized using the position indicated by a cursor in a sketching and editing tool or the like for drawing a picture and editing an image using the cursor, for example. A user can select and use any of these functions.

As an interface for realizing such operations, an interface capable of specifying a predetermined region with a cursor or the like, thereby selecting a function corresponding to the specified region has been suggested, as disclosed in JP 7(1995)-84747 A, for example.

FIG. 13 shows an example of a screen displayed in a conventional sketching and editing tool. In the screen of the sketching and editing tool shown in FIG. 13, icons indicating various functions such as an eraser function, a selecting function and a drawing function are arranged altogether in an icon menu 81 or an icon box 82. A user can select any of these icons, thereby selecting the functions.

In the sketching tool shown in FIG. 13, when a user wants to use an eraser function, for example, he/she clicks an eraser icon in the icon menu 81 or the icon box 82, thereby selecting the eraser function. At this time, a display mode of the selected eraser icon changes. This allows a user to recognize that the currently selected function is the eraser function. FIG. 14A shows an example of the display mode of the icons in the state where no function in the icon box 82 is selected, and FIG. 14B shows an example of the display mode of the icons in the state where the eraser function is selected. There is also an example in which the shape of a cursor is turned into that of an eraser when the eraser function is selected, thereby showing that the currently selected function is the eraser function.

### SUMMARY OF THE INVENTION

Generally, the icon menu 81 is displayed at the edge of the screen. On the other hand, in a sketching and editing tool or the like, for example, a user works near the center of the screen in many cases. Thus, every time a user selects a function, he/she has to move the cursor or the position at which his/her attention is focused from where he/she works currently to the edge of the screen. In order to avoid this, the icon box 82 may be arranged near the work position. In this case, when there are many functions to be displayed in the icon box 82, the area in the screen that is hidden by the icon box 82 increases, thus interfering with the user's work. As described above, there are many cases where the display of icons hinders the user from working smoothly. Therefore, the user interface in the conventional information processing apparatus has often had a poor operability for a user.

Accordingly, it is an object of the present invention to provide an information processing apparatus and a program including a user interface with an improved operability.

An information processing apparatus according to the present invention is an information processing apparatus connected with a display device and an input device, including a pointer symbol data recording portion in which pointer symbol display data representing a display mode of a pointer symbol indicating a position on a screen of the display device are prerecorded, a selection symbol data recording portion in which selection symbol display data representing a display mode of selection symbols that are displayed in the display device and respectively represent a plurality of functions are prerecorded, a pointer symbol display portion for displaying the pointer symbol such that a display position of the pointer symbol is moved by an input from the input device based on the pointer symbol display data, a selection symbol display portion for displaying the selection symbols in such a manner as to be selectable by an input from the input device based on the selection symbol display data, a function executing portion for executing any of the plurality of functions that are realized by an operation using information representing the position indicated by the pointer symbol, a function selecting portion for detecting that any of the plurality of functions represented by the selection symbols is selected by the input from the input device and changing the function to be executed by the function executing portion into the selected function, a selection symbol control portion for clearing a display of the selection symbol representing the selected function when the function selecting portion changes the function to be executed by the function executing portion into the selected function, and a pointer symbol control portion for changing the display mode of the pointer symbol according to the selected function when the function selecting portion changes the function to be executed by the function executing portion into the selected function.

The selection symbol is a symbol displayed by a picture, a character, a sign or a combination thereof. A user can select the selection symbol with the pointer symbol or the like, thereby utilizing a predetermined function provided in the information processing apparatus. The selection symbol may be movable by an operation of a user to an arbitrary position on the screen or displayed in such a manner as to be fixed at a predetermined position on the screen. The selection symbol includes, for example, an icon, a button, a pull-down menu and a pop-up menu.

The pointer symbol includes, for example, a cursor (for example, a mouse cursor or a mouse pointer) that moves on the screen with the movement of a pointing device such as a mouse or a trackball and a cursor that moves on the screen with the movement of a stylus.

With the information processing apparatus according to the present invention, the selection symbol on the screen is selected, whereby when a function executed by the function executing portion is changed, the selection symbol control portion clears the display of the selected selection symbol and the pointer symbol control portion changes the display mode of the pointer symbol. Accordingly, the display is shown as if the function indicated by the selected selection symbol were transferred to the pointer symbol. This allows a user to perceive as if he/she picked up a tool having a shape of the selection symbol. Consequently, an interface that is easy for a user to understand intuitively and has an improved operability is provided. It should be noted that the display mode of the pointer symbol is determined mainly by the shape, pattern or color of the pointer symbol or a combination thereof.

A program according to the present invention is a program allowing a computer connected with a display device and an input device to execute a pointer symbol display operation of reading pointer symbol display data representing a display mode of a pointer symbol indicating a position on a screen of the display device from a pointer symbol data recording portion in which the pointer symbol display data are prerecorded, displaying the pointer symbol and moving a display position of the pointer symbol by an input from the input device, a selection symbol display operation of reading selection symbol display data representing a display mode of selection symbols that are displayed in the display device and respectively represent a plurality of functions from a selection symbol data recording portion in which the selection symbol display data are prerecorded and displaying the selection symbols in such a manner as to be selectable by an input from the input device, a function executing operation of executing any of the plurality of functions that are realized by an operation using information representing the position indicated by the pointer symbol, a function selecting operation of detecting that any of the plurality of functions represented by the selection symbols is selected by the input from the input device and changing the function to be executed in the function executing operation into the selected function, a selection symbol control operation of clearing a display of the selection symbol representing the selected function when the function to be executed in the function executing operation is changed into the selected function in the function selecting operation, and a pointer symbol control operation of changing the display mode of the pointer symbol according to the selected function when the function to be executed in the function executing operation is changed into the selected function in the function selecting operation.

The present invention makes it possible to provide an information processing apparatus and a program that include a user interface having an improved operability.

### BRIEF DESCRIPTION OF THE DRAWINGS

FIG. 1 is a functional block diagram showing an example of a configuration of an information processing apparatus in Embodiment 1.

FIG. 2 illustrates an example of a screen displayed in a display device 6 of an information processing apparatus 1.

FIG. 3A illustrates an example of a data structure of icon display data 13, and FIG. 3B illustrates an example of a data structure of cursor display data 12.

FIG. 4 is a flowchart showing a flow of an operation conducted by the information processing apparatus 1 when a function is changed.

FIGS. 5A, 5B, 5C and 5D illustrate an example of a transition of a screen display in the operation shown in FIG. 4.

FIGS. 6A and 6B are flowcharts showing an example of a flow of an operation in which a function selecting portion 4 judges whether or not a function is deselected.

FIG. 7 is a drawing showing a desk and tools for working.

FIGS. 8A, 8B, 8C and 8D illustrate an example of a transition of a screen display in Embodiment 2.

FIG. 9 illustrates an example of a data structure of icon display data 33 in Embodiment 2.

FIG. 10 illustrates an example of a transition of a screen display in a variation example.

FIGS. 11A, 11B, 11C and 11D illustrate an example of a transition of a screen display in the variation example.

FIGS. 12A, 12B, 12C and 12D illustrate an example of a screen display in the case of temporarily enlarging an icon.

FIG. 13 illustrates an example of a screen displayed in a conventional sketching and editing tool.

FIGS. 14A and 14B illustrate an example of a display mode of an icon box 82.

### DETAILED DESCRIPTION OF THE INVENTION

In the information processing apparatus according to the present invention, it is preferable that the function selecting portion detects an input of deselecting the selected function from the input device and changes the function to be executed by the function executing portion from the selected function to a function before the selection, and when the function selecting portion changes the function to be executed by the function executing portion into the function before the selection, the selection symbol control portion displays the selection symbol representing the selected function near a position of the pointer symbol at a time of the change.

The selection symbol control portion displays the selection symbol corresponding to the deselected function near the position of the pointer symbol at the time of the change when the function that has been selected as the function to be executed by the function executing portion is deselected and changed into the function before the selection, so that the selection symbol representing the deselected function is displayed as if it was taken out from the pointer symbol and left at that position. A user can perceive as if he/she put down the tool that he/she finished using at that position.

In the information processing apparatus according to the present invention, it is preferable that the function selecting portion detects an input of deselecting the selected function from the input device and changes the function to be executed by the function executing portion from the selected function to a function before the selection, and when the function selecting portion changes the function to be executed by the function executing portion into the function before the selection, the selection symbol control portion displays the selection symbol representing the selected function in a predetermined selection symbol display region.

The selection symbol control portion displays the selection symbol corresponding to the deselected function in the predetermined selection symbol display region when the function that has been selected as the function to be executed by the function executing portion is deselected and changed into the function before the selection, so that the display position of the selection symbols is organized automatically. Thus, the selection symbol representing the function used before the change is organized and displayed in a region that does not interfere with the user's work, for example.

In the information processing apparatus according to the present invention, it is preferable that the function selecting portion detects the input of deselecting the selected function from the input device and changes the function to be executed by the function executing portion from the selected function to the function before the selection, and when the function selecting portion changes the function to be executed by the function executing portion into the function before the selection, the selection symbol control portion displays the selection symbol representing the selected function at a position closest to a position of the pointer symbol at a time of the change in the selection symbol display region.

In this way, the selection symbol is automatically arranged near a region in which work is carried out with the pointer symbol. Accordingly, for example, the selection symbols representing the functions frequently used by a user are organized and displayed in a region that does not interfere with the work and at a position close to the work site.

In the information processing apparatus according to the present invention, it is preferable that the function selecting portion detects an input of deselecting the selected function from the input device and changes the function to be executed by the function executing portion from the selected function to the function before the selection, and when the function selecting portion changes the function to be executed by the function executing portion from the selected function to the function before the selection, the pointer symbol control portion changes the display mode of the pointer symbol according to the function before the selection.

In the case where the selected function is deselected, the pointer symbol control portion varies the display mode of the pointer symbol according to the function before the deselected function is selected, so as to display how the deselected function is taken out and restored to its original function.

In the information processing apparatus according to the present invention, it is preferable that when the function selecting portion changes the function to be executed by the function executing portion, the selection symbol control portion displays the selection symbol representing the function before the change near a position of the pointer symbol at a time of the change.

The selection symbol control portion displays the selection symbol corresponding to the function before the change near the position of the pointer symbol at the time of the change when the function to be executed by the function executing portion is changed, so that the selection symbol representing the function used before the change is displayed as if it was taken out from the pointer symbol and left at that position. A user can perceive as if he/she put down the tool that he/she finished using at that position.

In the information processing apparatus according to the present invention, it is preferable that when the function selecting portion changes the function to be executed by the function executing portion, the selection symbol control portion displays the selection symbol representing the function before the change in a predetermined selection symbol display region.

The selection symbol control portion displays the selection symbol corresponding to the function before the change in the predetermined selection symbol display region when the function to be executed by the function executing portion is changed, so that the display position of the selection symbols is organized automatically. Thus, the selection symbol representing the function used before the change is organized and displayed in a region that does not interfere with the user's work, for example.

In the information processing apparatus according to the present invention, it is preferable that when the function selecting portion changes the function to be executed by the function executing portion, the selection symbol control portion displays the selection symbol representing the function before the change at a position closest to the position of the pointer symbol at a time of the change in the selection symbol display region.

In this way, the selection symbol is automatically arranged near a region in which work is carried out with the pointer symbol. Accordingly, for example, the selection symbols representing the functions frequently used by a user are organized and displayed in a region that does not interfere with the work and at a position close to the work site.

In the information processing apparatus according to the present invention, it is preferable that when the function selecting portion changes the function to be executed by the function executing portion, the pointer symbol control portion changes the display mode of the pointer symbol into a display mode that is the same as or similar to the display mode of the selection symbol representing the function after the change.

In the case where the function of the pointer symbol is changed, the pointer symbol control portion varies the display mode of the pointer symbol into the display mode that is the same as or similar to the display mode of the selected selection symbol, so as to more noticeably display how the function represented by the selected selection symbol is transferred to the pointer symbol.

The program stored in the recording medium according to the present invention is a program allowing a computer that is connected with a display device and an input device and includes a recording portion in which display data representing the display modes of the pointer symbol and the selection symbols displayed in the display device are prerecorded to execute a pointer symbol display operation of displaying the pointer symbol that indicates a position on a screen of the display device and moves a position to be displayed by an input from the input device according to the display modes representing the display data in the recording portion, a selection symbol display operation of displaying the selection symbols that respectively represent a plurality of functions and are selected by the input from the input device according to the display modes representing the display data in the recording portion, a function executing operation of executing any of the plurality of functions that are realized by an operation using information representing the position indicated by the pointer symbol, a function selecting operation of detecting that any of the plurality of functions represented by the selection symbols is selected by the input from the input device and changing the function to be executed in the function executing operation into the selected function, a selection symbol control operation of clearing a display of the selection symbol representing the selected function when the function to be executed in the function executing operation is changed into the selected function in the function selecting operation, and a pointer symbol control operation of changing the display mode of the pointer symbol according to the selected function when the function to be executed in the function executing operation is changed into the selected function in the function selecting operation.

The program stored in the recording medium according to the present invention can further allow a computer to execute as the function selecting operation, an operation of detecting an input of deselecting the selected function from the input device and changing the function to be executed in the function executing operation from the selected function to a function before the selection, and as the selection symbol control operation, an operation of displaying the selection symbol representing the selected function near a position of the pointer symbol at a time of the change when the function to be executed in the function executing operation is changed into the function before the selection in the function selecting operation.

The program stored in the recording medium according to the present invention can allow a computer to execute as the function selecting operation, an operation of detecting an input of deselecting the selected function from the input device and changing the function to be executed in the function executing operation from the selected function to a function before the selection, and as the selection symbol control operation, an operation of displaying the selection symbol representing the selected function in a predetermined selection symbol display region when the function to be executed in the function executing operation is changed into the function before the selection in the function selecting operation.

The program stored in the recording medium according to the present invention can allow a computer to execute as the function selecting operation, the operation of detecting the input of deselecting the selected function from the input device and changing the function to be executed in the function executing operation from the selected function to the function before the selection, and as the selection symbol control operation, an operation of displaying the selection symbol representing the selected function at a position closest to the position of the pointer symbol at a time of the change in the selection symbol display region when the function to be executed in the function executing operation is changed into the function before the selection in the function selecting operation.

The program stored in the recording medium according to the present invention can allow a computer to execute as the function selecting operation, an operation of detecting an input of deselecting the selected function from the input device and changing the function to be executed in the function executing operation from the selected function to the function before the selection, and as the pointer symbol control operation, an operation of changing the display mode of the pointer symbol according to the function before the selection when the function to be executed in the function executing operation is changed from the selected function to the function before the selection in the function selecting operation.

The program stored in the recording medium according to the present invention can allow a computer to execute, as the selection symbol control operation, an operation of displaying the selection symbol representing the function before the change near a position of the pointer symbol at a time of the change when the function to be executed in the function executing operation is changed in the function selecting operation.

The program stored in the recording medium according to the present invention can allow a computer to execute, as the selection symbol control operation, an operation of displaying the selection symbol representing the function before the change in a predetermined selection symbol display region when the function to be executed in the function executing operation is changed in the function selecting operation.

The program stored in the recording medium according to the present invention can allow a computer to execute, as the selection symbol control operation, an operation of displaying the selection symbol representing the function before the change at a position closest to the position of the pointer symbol at a time of the change in the selection symbol display region when the function to be executed in the function executing operation is changed in the function selecting operation.

The program stored in the recording medium according to the present invention can allow a computer to execute, as the pointer symbol control operation, an operation of changing the display mode of the pointer symbol into a display mode that is the same as or similar to the display mode of the selection symbol representing the function after the change when the function to be executed in the function executing operation is changed in the function selecting operation.

The following is a description of embodiments of the present invention, with reference to the accompanying drawings.

### Embodiment 1

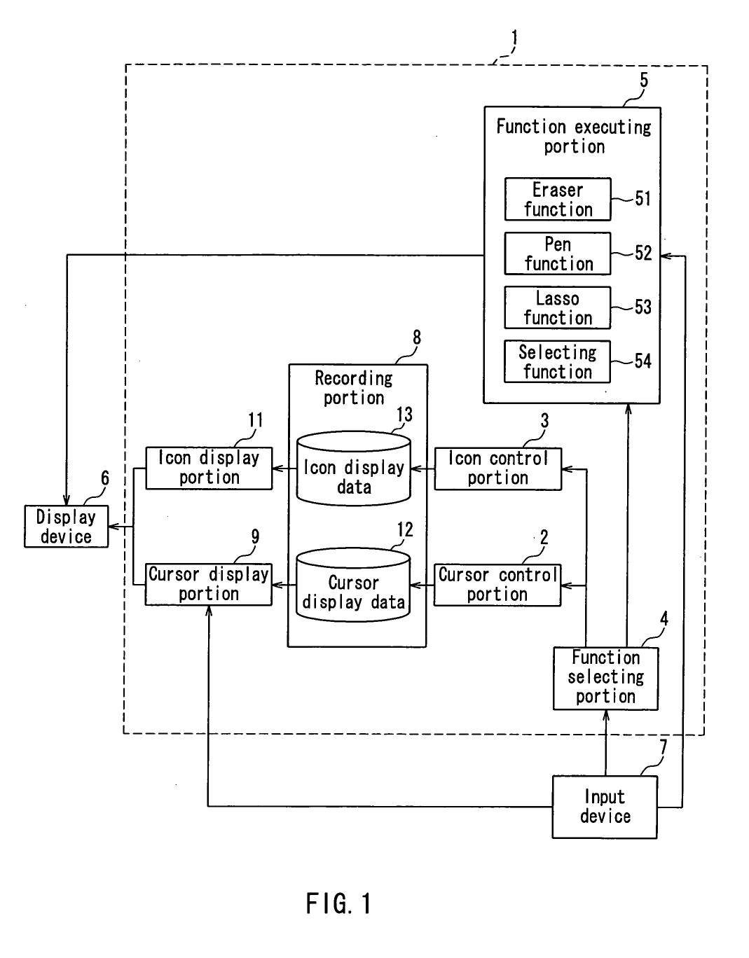

FIG. 1 is a functional block diagram showing an example of a configuration of an information processing apparatus in Embodiment 1. An information processing apparatus 1 shown in FIG. 1 includes a cursor control portion 2, a cursor display portion 9, an icon control portion 3, an icon display portion 11, a function selecting portion 4, a function executing portion 5 and a recording portion 8. The information processing apparatus 1 is connected with a display device 6 and an input device 7.

The information processing apparatus 1 includes a graphic user interface (in the following, referred to as GUI) in which a user can input information in the information processing apparatus 1 by operating a cursor, which is a pointer symbol indicating a position on a screen of the display device 6, using the input device 7. The present embodiment describes as an example the case in which the above-mentioned GUI is used in a sketching and editing tool for drawing a picture and editing an image using a cursor.

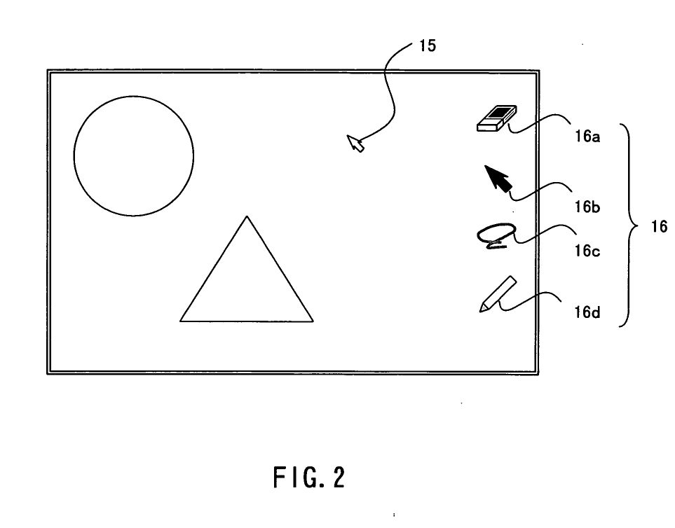

FIG. 2 illustrates an example of a screen displayed on the display device 6 as the GUI of the information processing apparatus 1. A cursor 15 displayed on the screen shown in FIG. 2 moves on the screen according to the input from the input device 7. A user can select an object such as an icon or a button displayed at a position indicated by the cursor 15 via the input device 7. Such a selecting function of selecting an object using the cursor 15 is generally provided in a GUI. In the following, such a selecting function is referred to as a default function.

Besides the selecting function as the default function, a plurality of functions including, for example, a pen function (a handwriting input function) for specifying a position on the screen using the cursor 15 so as to draw a figure, an eraser function for specifying a position on the screen using the cursor 15 so as to erase a figure such as a drawing object, and the like are provided as a function realized by an operation using the position of the cursor 15. In the screen shown in FIG. 2, individual icons 16 serving as selection symbols represent a plurality of functions, respectively. For example, an eraser icon 16a represents an eraser function, an arrow icon 16b represents a selecting function, a lasso icon 16c represents a lasso function, and a pen icon 16d represents a pen function. A user can select the eraser icon 16a, thereby utilizing the eraser function represented by the eraser icon 16a, for example.

As shown in FIG. 1, the function executing portion 5 selects and executes any one of an eraser function 51, a pen function 52, a lasso function 53 and a selecting function 54 according to the input from the input device 7. The function selecting portion 4 controls which of these functions is executed by the function executing portion 5. The result of the execution by the operation of the function executing portion 5 is displayed in the display device 6, for example.

The eraser function 51, the pen function 52, the lasso function 53 and the selecting function 54 are executed by the function executing portion 5 using positional information indicating a position on the screen indicated by the cursor 15. For example, an operation of inputting data in correspondence with a position indicated by the cursor 15 or an operation of changing data associated with a position indicated by the cursor 15 is executed. More specifically, the eraser function 51 is realized by an operation of deleting a drawing object located at the position indicated by the cursor 15. The pen function 52 is realized by an operation of drawing a figure at the position indicated by the cursor 15. The lasso function 53 is realized by an operation of selecting a surrounded area when a drawing object is surrounded by a trace of a dragged cursor 15. The selecting function 54 is realized by an operation of bringing a drawing object located at a position indicated by the cursor 15 into a selected state.

The icon control portion 3 controls the display of the icons 16 to be displayed on the display device 6 by updating the icon display data 13 recorded in the recording portion 8. The icon display portion 11 displays the icons 16 on the display device 6 based on the icon display data 13. The icons 16 to be displayed are, for example, symbols representing functions that are likely to be executed by the function executing portion 5 by a picture, a character, a sign or a combination thereof. The icon display data 13 are, for example, data representing a display mode of the shape, color or pattern of the icons 16 or a combination thereof. Icons representing the eraser function 51, the pen function 52, the lasso function 53 and the selecting function 54 respectively are included.

The cursor control portion 2 controls the display of the cursor 15 to be displayed on the display device 6 by updating cursor display data 12 recorded in the recording portion 8. The cursor display portion 9 displays the cursor 15 on the display device 6 based on the cursor display data 12. The cursor display data 12 are, for example, data representing a display mode of the shape, color or pattern of the cursor 15 or a combination thereof. Further, the position of the cursor 15 displayed by the cursor display portion 9 moves based on the input from the input device 7.

The function selecting portion 4 detects that the icon 16 on the screen is selected by the input from the input device 7 and changes the function to be executed by the function executing portion 5 into the function represented by the selected icon 16. For example, in the case where the selecting function 54 is set as the function to be executed by the function executing portion 5, when the function selecting portion 4 detects that the eraser icon 16a is selected, it changes the function to be executed by the function executing portion 5 into the eraser function 51.

Further, in the case where the function to be executed by the function executing portion 5 is changed, the function selecting portion 4 causes the icon display portion 11 and the cursor display portion 9 to update the display of the icon 16 and the cursor 15 via the icon control portion 3 and the cursor control portion 2.

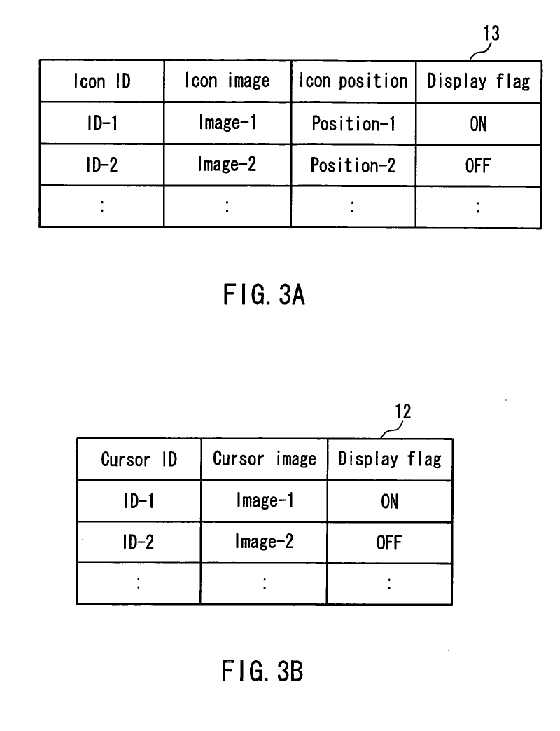

Herein, an example of a data structure of the icon display data 13 and the cursor display data 12 will be described referring to FIG. 3. FIG. 3A illustrates an example of the data structure of the icon display data 13. The icon display data 13 are, for example, data recorded such that an icon ID for identifying each icon is in correspondence with an image of the icon to be displayed, a position at which the icon is displayed, a display flag indicating the presence or absence of the display or the like.

FIG. 3B illustrates an example of the data structure of the cursor display data 12. The cursor display data 12 are, for example, data recorded such that a cursor ID for identifying a display mode of the cursor, an image of the cursor to be displayed, a display flag indicating whether or not the cursor is to be displayed, etc. are in correspondence with each other. By making the value of the cursor ID equal to the value of the corresponding icon ID, for example, it is possible to bring the icon display data 13 and the cursor display data 12 into correspondence with each other.

The information processing apparatus 1 can be configured, for example, by installing a predetermined program in a computer such as a personal computer, a workstation or a server. A CPU executes a predetermined program, making it possible to realize the functions of the cursor control portion 2, the cursor display portion 9, the icon control portion 3, the icon display portion 11, the function selecting portion 4 and the function executing portion 5. Incidentally, in order to realize a part of the functions of the cursor control portion 2, the cursor display portion 9, the icon control portion 3, the icon display portion 11, the function selecting portion 4 and the function executing portion 5, it also may be possible to use the function provided by an OS (operating system) in a computer.

The recording portion 8 can be not only a storage medium such as a hard disk or a RAM incorporated into a computer but also a portable storage medium such as a flexible disk or a memory card or a storage medium in a storage device on a network.

As the display device 6, it is possible to use a CRT, a PDP, a LCD, a SED (Surface-conduction Electron-emitter Display) or the like, for example. As the input device 7, not only generally-used mouse and keyboard but also an input device such as a stylus and a tablet device, for example, may be used.

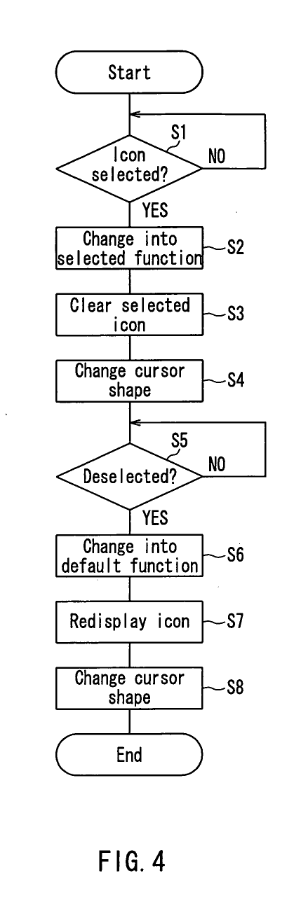

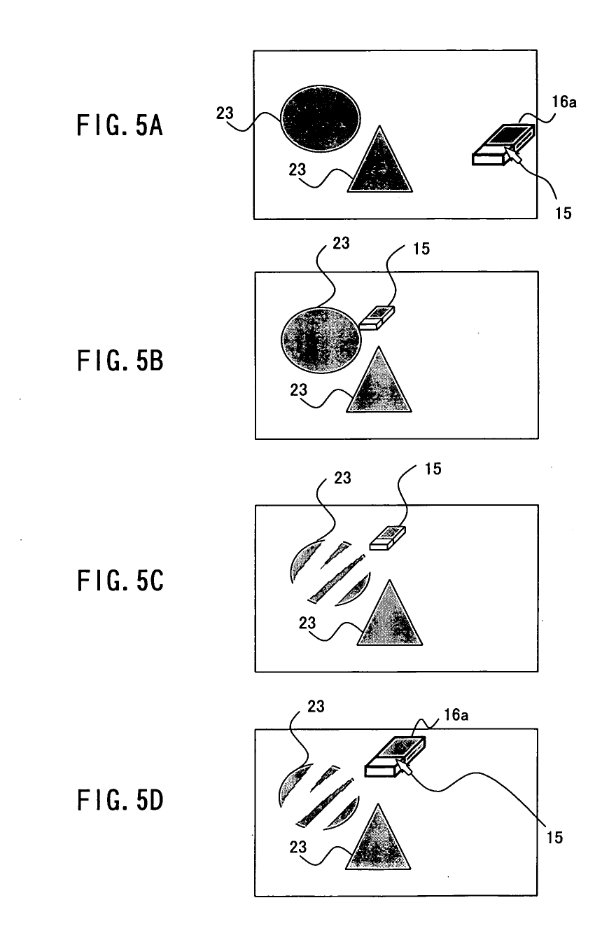

Now, the operation of the information processing apparatus 1 will be described referring to FIGS. 4 and 5. FIG. 4 is a flowchart showing a flow of an operation carried out by the information processing apparatus 1 in the case where the icon 16 is selected and the function of the cursor 15 is changed. FIGS. 5A, 5B, 5C and 5D illustrate an example of a transition of a screen display in the operation shown in FIG. 4. The screen display makes transition in the alphabetical order, i.e., 5A, 5B, 5C and 5D.

First, the function selecting portion 4 detects that any of the icons 16 on the screen is selected (YES in Step S1). In this way, the function selecting portion 4 detects that the function represented by the selected icon 16 is selected. For example, in the case where the eraser icon 16a representing the eraser function 51 among the icons 16 is clicked using the cursor 15 (see FIG. 5A), the function selecting portion 4 detects that the eraser icon 16a is selected. In other words, the function selecting portion 4 detects that the eraser function is selected. The function executed by the function executing portion 5 when the eraser icon 16a is selected is the selecting function 54, which is the default function. In the following, the operation in the case where the eraser icon 16a is selected will be described as an example.

The function selecting portion 4 changes the function to be executed by the function executing portion 5 from the default function to the eraser function 51 (Step S2). In this way, the function executing portion 5 executes the eraser function 51 based on the input from the input device 7. For example, in the case where the cursor 15 moves over a drawing object while being kept dragged, the function executing portion 5 performs an operation of erasing the drawing object in a portion corresponding to the trace of the cursor 15.

The function selecting portion 4 notifies the icon control portion 3 and the cursor control portion 2 that the eraser icon 16a is selected. The icon control portion 3 clears the display of the selected icon, namely, the eraser icon 16a from the screen (Step S3). The icon control portion 3 turns OFF a display flag in the data representing the eraser icon 16a in the icon display data 13, for example. Thereafter, the icon display portion 11 updates the display of the icon based on the icon display data 13. At this time, since the icon display portion 11 does not display the icon whose display flag is turned OFF, the eraser icon 16a is not displayed on the screen and cleared therefrom (FIG. 5B).

As the eraser icon 16a is cleared, the cursor control portion 2 almost simultaneously changes the shape of the cursor (Step S4). The cursor control portion 2 turns ON a display flag of a cursor ID having a value equal to that of the icon ID of the eraser icon 16a in the cursor display data 12, for example. The cursor display portion 9 displays a cursor image of data whose display flag is turned ON as the shape of the cursor 15. In other words, the cursor image corresponding to the cursor ID having a value equal to that of the icon ID is displayed as the cursor shape.

It is preferable that this cursor image is a reduced image of the icon image of the eraser icon 16a. In this way, the cursor 15 is changed into a shape that is the same as the eraser icon 16a and smaller than the same (see FIG. 5B). The cursor 15 is displayed so as to be smaller than the eraser icon 16a because it is easier for a user to recognize the position indicated by the cursor 15.

Here, the cursor image and the icon image corresponding thereto may have a similar shape. As an example of the case where the cursor image and the icon image are similar, the icon image may have a shape of a combination of a figure and characters and the cursor image may have a shape of the figure alone. Also, in addition to the case where the cursor shape and the icon shape are visually similar, they may be conceptually similar. For example, when the icon has an eraser shape and the cursor has another eraser shape, they can be considered similar because both of them recall a common concept of “eraser.” Similarly, when the icon is displayed with the characters “eraser” and the cursor has a shape of an eraser, they can be considered similar.

By the operations in Steps S3 and S4 described above, it becomes possible to display as if a user actually picked up a tool with an icon shape (here, an eraser as an example). Thus, a user can conduct an operation that is easy to understand intuitively as if he/she used an actual tool.

The function executing portion 5 conducts an operation of erasing the figure (for example, a drawing object 23) in a portion on the screen specified by the cursor 15 in response to an operation of the input device 7 by a user (see FIG. 5C). When the user finishes using the eraser function 51, he/she conducts an operation for deselecting the eraser function 51. Here, the deselection refers to changing the currently selected function into the default function, for example. By the deselection, the function that has been selected stops.

The function selecting portion 4 detects that the eraser function 51 is deselected (Step S5). The function selecting portion 4 detects the user's operation of left-clicking on a certain position on the screen with the cursor 15, for example, and when no figure is present at the clicked position, judges that the deselection is inputted. Further, in the case of detecting a right-click, the function selecting portion 4 can also judge that it is an input of the deselection regardless of whether or not any figure is present at this position. Incidentally, a specific example of a method for judging whether or not the input by the user is the deselection will be described later.

When the eraser function 51 is deselected (YES in Step S5), the function selecting portion 4 changes the function to be executed by the function executing portion 5 from the eraser function 51 to the default function (Step S6). Further, the function selecting portion 4 notifies the icon control portion 3 and the cursor control portion 2 that the eraser icon 16a is selected.

The icon control portion 3 redisplays the eraser icon 16a at the position of the cursor 15 at the time of the deselection (Step S7). The icon control portion 3, for example, turns ON the display flag in the data representing the eraser icon 16a in the icon display data 13 and updates the icon position so as to be the cursor position at the time of the deselection. Thereafter, the icon display portion 11 updates the display of the icon based on the icon display data 13. At this time, the icon display portion 11 displays the eraser icon 16a whose display flag is turned ON at the cursor position.

Here, it is appropriate that the position at which the eraser icon 16a is displayed is near the position of the cursor 15 if not exactly the same. For example, in the case where the drawing object 23 is located close to the cursor 15, the icon control portion 3 updates the icon position of the eraser icon 16a so as to be at a position that is near the cursor position and does not overlap the drawing object 23. As a result, the icon display portion 11 displays the eraser icon 16a in such a manner as to be shifted slightly so that the eraser icon 16a does not overlap the drawing object 23.

As the eraser icon 16a is redisplayed, the cursor control portion 2 almost simultaneously changes the shape of the cursor 15 (Step S8). The cursor control portion 2 turns OFF the display flag of the cursor ID having a value equal to that of the icon ID of the eraser icon 16a in the cursor display data 12, for example. Consequently, the display flag is turned OFF in all of the data recorded in the cursor display data 12. In this case, the cursor display portion 9 displays the cursor image of the default function as the cursor shape. For example, the cursor 15 is changed into an arrow shape representing the selecting function 54, which is the default function (see FIG. 5D).

By the operations in Steps S7 and S8 described above, it is possible to display as if an eraser is put at the position of the cursor 15 at the time of the deselection. Thus, a user can conduct an operation that is easy to understand intuitively as if he/she put a tool that he/she finished using at that position. Also, since the icon is redisplayed at the position where the user finishes using the tool, the user can always keep icons representing frequently-used functions close to a work position. Further, the user can arrange the icons in such a manner as to be scattered appropriately according to a working situation. This also prevents a plurality of the icons displayed together at a specific position from hiding a working screen and hindering the work. Moreover, the user need not take the trouble to move the cursor to a position away from the work position in order to conduct the deselection, allowing a smooth work.

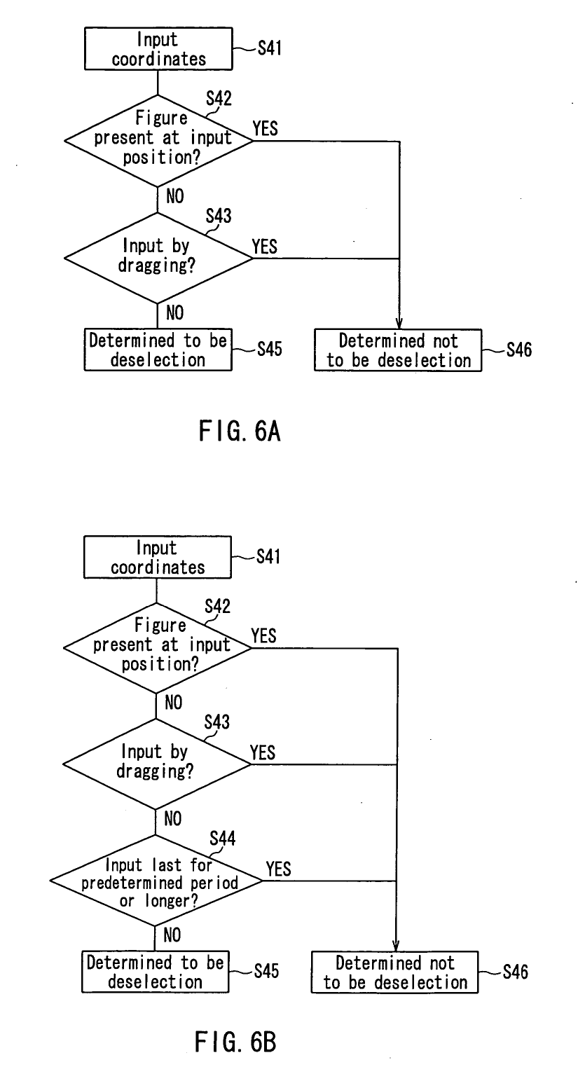

Now, the following is a description of a specific example of how to judge whether or not the function is deselected in Step S5 described above. FIGS. 6A and 6B are flowcharts showing an example of a flow of the operation in which the function selecting portion 4 judges whether or not the function is deselected.

FIG. 6A shows an operation in the case where, while the eraser function 51 is selected as the function to be executed by the function executing portion 5, coordinates indicating a position on the screen are inputted by a user's clicking or dragging operation. When the coordinates are inputted by the user's operation (Step S41), the function selecting portion 4 judges whether or not any figure (for example, the drawing object 23 or the like) to be erased by the eraser function 51 is present at the position of the inputted coordinates. If a figure is present at the position of the inputted coordinates (YES in Step S42), it is determined that the function is not deselected (Step S46). In other words, in the case where a figure is present at the position inputted by the clicking or dragging operation, an operation of not deselecting the eraser function 51 but erasing the figure or a part of the figure at that position is conducted.

If no figure is present at the position of the inputted coordinates (NO in Step S42) and the coordinates are inputted by the dragging operation (YES in Step S43), it is determined that the function is not deselected (Step S46). If the coordinates are inputted not by the dragging operation but by the clicking operation (NO in Step S43), it is determined that this input is for deselecting the eraser function 51 (Step S45).

In this manner, when the user clicks a mouse or a pen at a position without any figure, for example, in the state where the eraser function 51 is selected, it is judged that the eraser function 51 is deselected, so that the eraser icon 16a is displayed at this position. The user can deselect the eraser function 51 as if he/she “put down an eraser that he/she finished using.”

FIG. 6B shows an operation in the case where, while the pen function 52 (the handwriting input function) is selected as the function to be executed by the function executing portion 5, coordinates indicating a position on the screen are inputted by a user's clicking or dragging operation. When the pen function 52 is selected, the function executing portion 5 draws a figure based on a position or a trace inputted by the user's clicking or dragging operation and outputs the figure onto the screen, for example.

In the case of the eraser function 51, if there is a click input at a position without any figure, it can be determined that the function is deselected. On the other hand, in the case of the pen function 52, a click input at a position without any figure might simply be an input for writing a small dot. Accordingly, in order to judge whether the user's operation is for writing or deselecting, it is preferable that the method for determining the deselection of the pen function 52 further includes a determination condition in addition to the method for determining the deselection of the eraser function 51 (see FIG. 6A). In an example illustrated by FIG. 6B, the function selecting portion 4 judges that the input is for writing a small dot when a mouse or a pen stays at the same position for a certain period. In other words, a click for a very short period is considered as a deselecting operation.

The operation illustrated by FIG. 6B includes an operation for determining an input period (Step S44) in addition to the operation illustrated by FIG. 6A. In other words, in the case where a figure is present at the inputted position (NO in Step S42) and this input is not by a dragging operation (NO in Step S43), its input period (a period of being clicked) is further judged (Step S44). If the input period is equal to or longer than a predetermined period (YES in Step S44), then it is judged not to be a deselecting operation but to be a writing operation (Step S46). If the input period is shorter than the above-mentioned predetermined period (NO in Step S44), it is judged to be the deselection of the pen function 52. The above-mentioned predetermined period can be set suitably according to situations. For example, the above-mentioned predetermined period can be set to 0.3 seconds.

Other than the operations illustrated by FIGS. 6A and 6B, it is possible to consider various deselecting operations. For example, in the case where a function different from the currently-selected function is selected, the function that has been selected is deselected automatically. Examples thereof include an operation in which, when the pen function 52 is selected in the state where the eraser function 51 is selected, the eraser function 51 is deselected automatically. Accordingly, the function to be selected is exclusive. In other words, only one kind of function can be selected at one time.

As still another deselecting operation, it is also possible to consider an operation in which, once a selected function is used, this function is deselected. Examples thereof include an operation in which, when a pen-up event occurs in the state where a certain function is selected, this function is deselected. For example, in the case where a user selects the eraser function 51 and then erases a certain figure by a dragging operation, the eraser function 51 is deselected when the dragging operation ends. In this case, the eraser icon is redisplayed near the position where the dragging operation ends, for example. As a yet another example, in the case where a user selects a picture description function of inputting a certain figure (for example, a circle), the function selecting portion 4 may deselect the picture description function at the time when one figure (circle) is inputted.

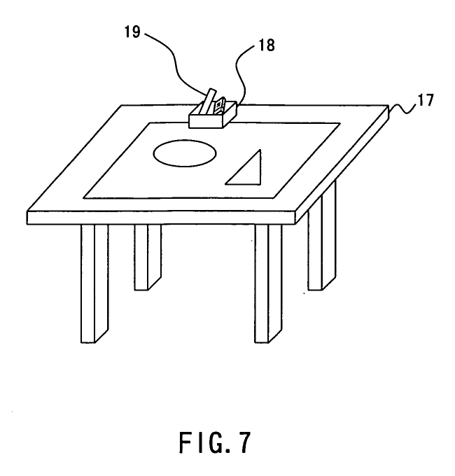

As described above, in accordance with the present embodiment, a GUI with improved operability can be provided. For example, it becomes possible for a user to conduct an operation as if he/she worked on a desk using tools such as a pen and an eraser. FIG. 7 is a drawing showing a desk and tools for working. An operation in which a user works using various functions in the information processing apparatus 1 can be compared to that in which a worker works using various tools 19 in a tool box 18 on a desk 17 shown in FIG. 7. In working on the desk 17, a worker may put the tools 19 such as a pen and an eraser at hand after using them and need not take the trouble to return them to the tool box 18. As a result, frequently-used tools are always located near the work position. The information processing apparatus 1 in the present embodiment can provide a GUI allowing an efficient and easy-to-understand operation such as that in the case of actually picking up and using tools as described above.

### Embodiment 2

In Embodiment 1, when a function is deselected, an icon of the deselected function is redisplayed at a position of a cursor at the time of the deselection. On the other hand, in Embodiment 2, when a function is deselected, an icon of the deselected function is redisplayed not at a position of a cursor but in a predetermined icon display region.

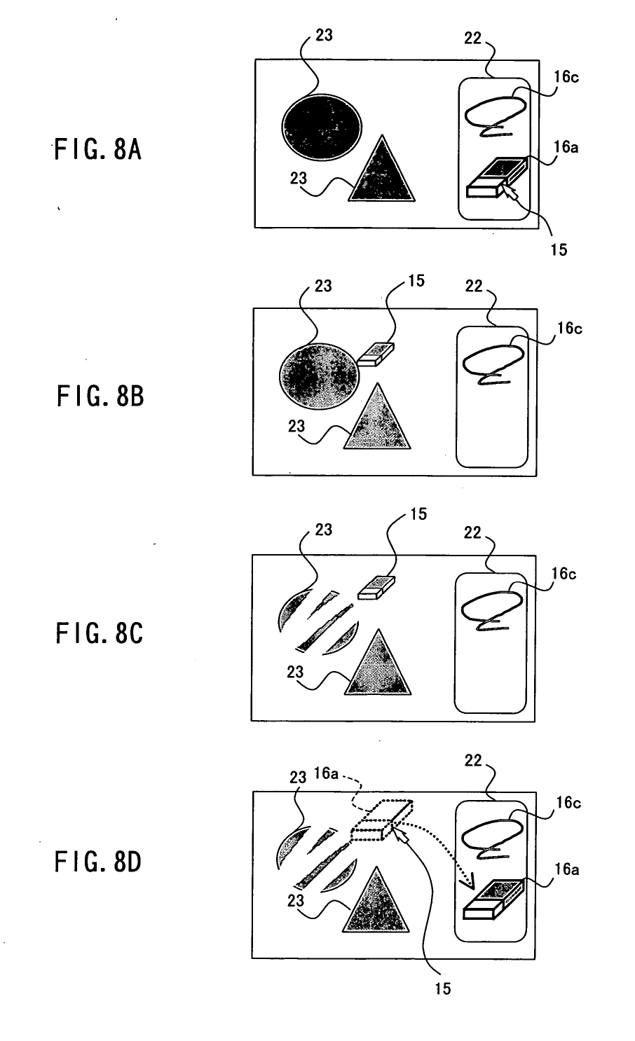

FIGS. 8A, 8B, 8C and 8D illustrate an example of a transition of a screen display in the present embodiment. The screen display makes transition in the alphabetical order, i.e., 8A, 8B, 8C and 8D.

In the screen shown in FIG. 8A, an eraser icon 16a arranged in an icon display region 22 is clicked on, whereby an eraser function 51 is selected. In the icon display region 22, a plurality of the icons 16a and 16c are grouped into one and displayed. In the screen shown in FIG. 8B, the eraser icon 16a in the icon display region 22 is cleared, and a cursor 15 is formed into an eraser shape. In the screen shown in FIG. 8C, the eraser function 51 is used.

FIG. 8D shows the screen displayed when the eraser function 51 is deselected. When the eraser function 51 is deselected, the eraser icon 16a is displayed only momentarily at the position of the cursor 15 and then displayed in the icon display region 22. The eraser icon 16a indicated by dotted lines in the figure shows the eraser icon 16a displayed only momentarily at the position of the cursor 15.

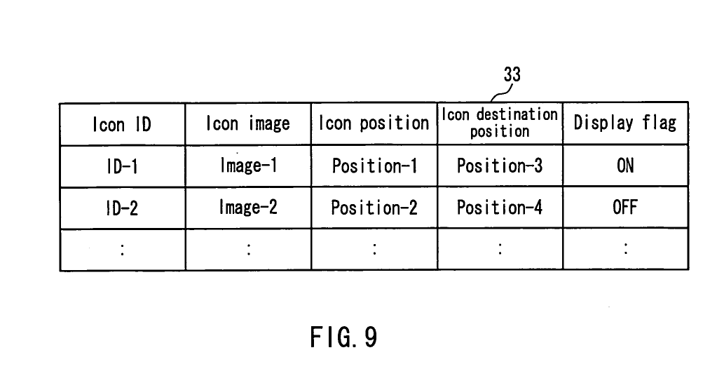

FIG. 9 illustrates an example of a data structure of icon display data 33 in the present embodiment. In the icon display data 33 shown in FIG. 9, an icon position and an icon destination position for each icon are recorded as information representing the icon position. For the icon position, a cursor position at the time of deselection is recorded, for example. For the icon destination position, a position inside the icon display region 22 is recorded, for example. It is noted that, since the configuration of an information processing apparatus in the present embodiment is similar to that of the information processing apparatus 1 shown in FIG. 1, the description thereof will be omitted.

The following is a description of an exemplary operation in which, when a function is deselected, the icon display portion 11 redisplays an icon corresponding to the deselected function.

When a function is deselected, the icon control portion 3 (see FIG. 1) updates the icon position of the icon corresponding to the deselected function in the icon display data 33 shown in FIG. 9 so as to be a cursor position at the time of the deselection, and updates the icon destination position so as to be a position at which the icon is to be displayed in the icon display region 22. The icon control portion 3 further updates the display flag of the icon corresponding to the deselected function from OFF to ON.

The icon display portion 11 only momentarily (for example, for 1 second) displays the icon corresponding to the data whose display flag is updated from OFF to ON in the icon display data 33 at a position indicated by the icon position. Thereafter, the icon display portion 11 moves the display position of the icon to a position indicated by the icon destination position. In this way, as shown in FIG. 8D, for example, the eraser icon 16a whose function is deselected is displayed momentarily at the position of the cursor 15 and then arranged in the icon display region 22.

When the above-described operation in which the icon whose function is deselected is automatically arranged in the predetermined icon display region 22 is compared to that in the case of working on the desk 17 shown in FIG. 7, it is similar to an operation in which a used tool is automatically stored in the tool box. By such an operation, the operability of the GUI improves in some cases. For example, since the icon representing the used function is rearranged automatically in the icon display region, a user need not take the trouble to move the cursor to the icon display region. This provides a user interface that is convenient for a user who does not want the icons to be scattered on the screen. Further, in another example, in the case where a user gives an explanation to audience while making annotations on an electronic blackboard or a presentation screen using a cursor of the pen function 52 or the like, the user can give the explanation more easily because the used tool (the icon representing the pen function 52) is always arranged at the same position.

### VARIATION EXAMPLE

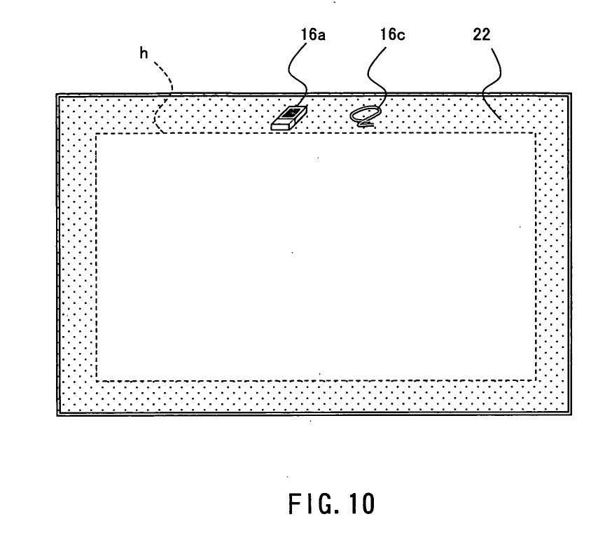

FIG. 10 illustrates an example of a screen display in a variation example of the present embodiment. In the present variation example, an icon display region 22 is provided around a work region. The work region is surrounded by a broken line h in FIG. 10. In the work region, a figure can be drawn by a sketching and editing tool, for example. When an icon representing a deselected function is redisplayed, it is redisplayed at a position that is in the icon display region 22 around the work region and closest to a work position.

In FIG. 10, the work region and the icon display region are displayed in such a manner as to be distinguishable. However, it is not always necessary to display these regions in a distinguishable manner. Furthermore, as to how the icon is displayed in the icon display region 22, all of the icons may be inside the icon display region 22 or a part of the icons may be inside the icon display region 22.

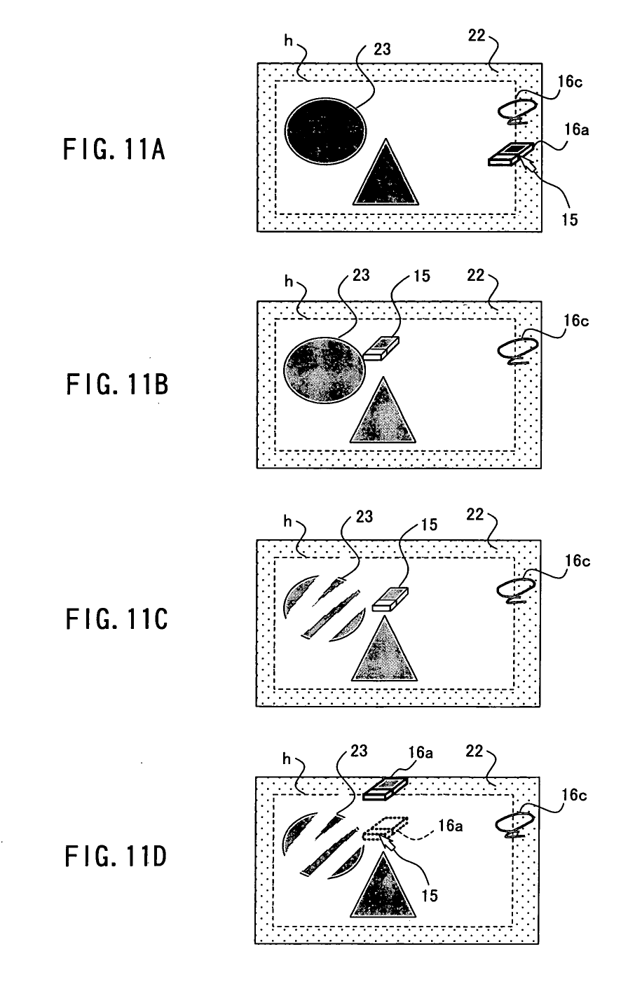

FIGS. 11A, 11B, 11C and 11D illustrate an example of a transition of a screen display in the present variation example. The screen display makes transition in the alphabetical order, i.e., 11A, 11B, 11C and 11D.

In the screen shown in FIG. 11A, an eraser icon 16a arranged in an icon display region 22 is clicked on, whereby an eraser function 51 is selected. In the screen shown in FIG. 11B, the eraser icon 16a in the icon display region 22 is cleared, a cursor 15 is formed into an eraser shape. In the screen shown in FIG. 11C, the eraser function 51 of the cursor 15 is used for erasing a part of a drawing object 23.

FIG. 11D shows the screen displayed when the eraser function 51 is deselected. When the eraser function 51 is deselected, the icon control portion 3 updates the icon position of the eraser icon 16a in the icon display data 33 (see FIG. 9) so as to be a cursor position and updates the icon destination position so as to be a position closest to the cursor position inside the icon display region 22. The icon control portion 3 further updates the display flag of the eraser icon 16a from OFF to ON. The icon display portion 11 only momentarily (for example, for 1 second) displays the icon corresponding to the data whose display flag is updated from OFF to ON in the icon display data 33 at a position indicated by the icon position. Thereafter, the icon display portion 11 moves the display position of the icon to a position indicated by the icon destination position.

By the above-described operation, the eraser icon 16a is displayed only momentarily at the position of the cursor 15 and then displayed at the position closest to the position of the cursor 15 in the icon display region 22. In other words, the eraser icon 16 is moved and displayed at an edge of the screen. The eraser icon 16a indicated by dotted lines in the figure shows the eraser icon 16a displayed only momentarily at the position of the cursor 15.

In the examples illustrated by FIGS. 8D and 11D, the eraser icon 16a is displayed at the position of the cursor 15 and then moves to the icon display region 22. Instead of the two-step display of the icon as described above, the icon may be displayed directly in the icon display region 22 when the function is deselected. For example, when the eraser function 51 is deselected by a clicking operation, the icon display portion 11 may display the eraser icon 16a directly in the icon display region 22 instead of displaying the eraser icon 16a at the clicked position and then moving the eraser icon 16a.

Further, it is preferable that the icon display portion 11 clearly displays a destination of the eraser icon 16a when displaying the eraser icon 16a at the position of the cursor 15 and then moving it to the icon display region 22. For example, at the time of moving the icon, the trace of the movement may be displayed in such a manner as to be clear to a user. In the example of the screen shown in FIG. 8D or 11D, the icon display portion 11 may display the movement of the eraser icon 16a from an origination to a destination by animation when the eraser icon 16a moves. This makes it easier for a user to know the destination of the eraser icon 16a.

As another display example, when moving the eraser icon 16a from the position of the cursor 15 to the icon display region 22, the icon display portion 11 may temporarily (for example, for 0.5 second) enlarge the eraser icon 16a and then restore the icon to an original size and display it.

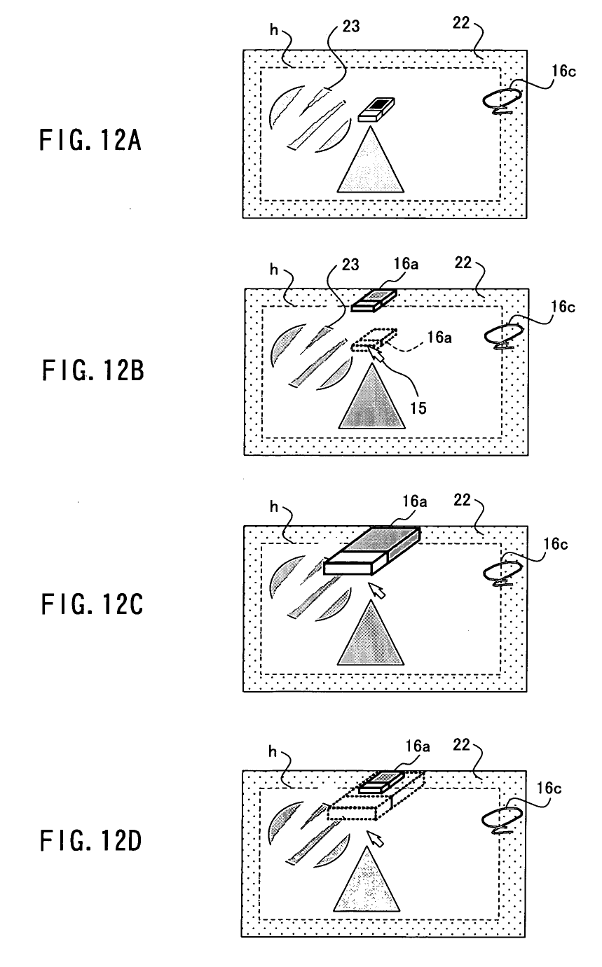

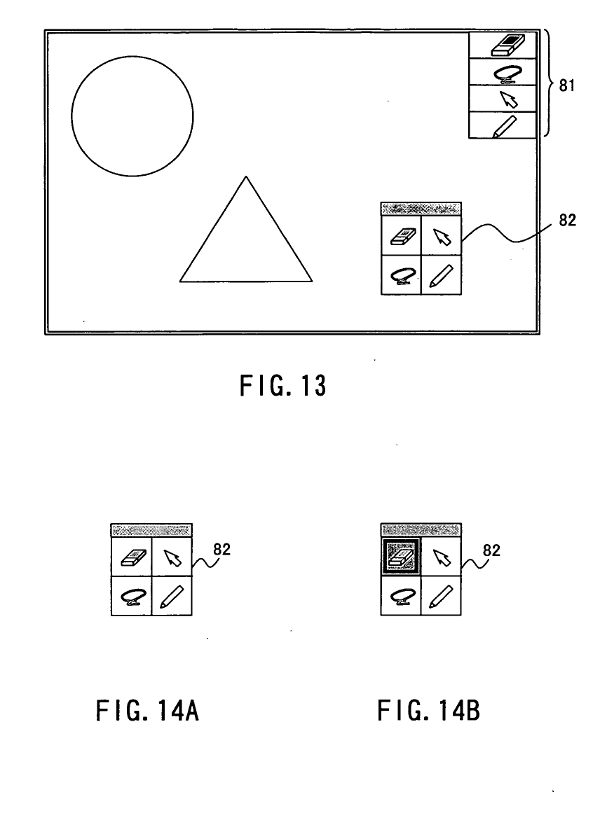

FIGS. 12A, 12B, 12C and 12D illustrate an example of a screen display in the case of temporarily enlarging the icon. The screen display makes transition in the alphabetical order, i.e., 12A, 12B, 12C and 12D.

In the screen shown in FIG. 12A, an eraser function 51 is selected as the function to be executed by the function executing portion 5. The eraser function 51 is deselected by, for example, a clicking operation. FIG. 12B shows the screen displayed in the case where the eraser function 51 is deselected. The cursor 15 turns into an arrow shape representing the default function, and the eraser icon 16a is momentarily displayed at the position of the cursor 15 and then arranged in the icon display region 22. FIG. 12C shows the screen in the case where, when the eraser icon 16a is displayed in the icon display region 22, the eraser icon 16a is temporarily enlarged and displayed. The eraser icon 16a that is temporarily enlarged and displayed is restored to its original size immediately, as shown in FIG. 12D. This makes it possible to show the destination of the eraser icon 16a clearly to a user.

The above description of Embodiments 1 and 2 has been directed to a mode in which the icon representing the deselected function is redisplayed at the position of the cursor at the time of deselection and that in which the icon representing the deselected function is redisplayed at the predetermined icon display region. These two modes can be realized by one information processing apparatus. In this case, it is preferable that a user can select which of these two modes is to be used.

Moreover, although Embodiments 1 and 2 have described an operation of displaying the cursor and the icon in the sketching and editing tool as an example, the present invention is not limited to the application to the case of using the sketching and editing tool. For example, in the case where there are a selecting function of specifying a position on a display screen and a scaling function of enlarging or reducing and displaying the selected position as selectable functions in a display tool for displaying a document or an image, the present invention is also applicable to an information processing apparatus for controlling the display of a button representing each function and the display of a cursor.

According to Embodiments 1 and 2 described above, a user can operate an icon and a cursor on the screen as if he/she was using an actual tool. Consequently, it is possible to achieve a GUI having an operability allowing even a user who is not accustomed to operate a computer to utilize a computer naturally.

An information processing apparatus and a program according to the present invention provide a user interface with an improved operability. Accordingly, the utilization of a computer is promoted, and the applicable field of a computer is also widened.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An information processing apparatus connected with a display device and an input device, comprising:
a pointer symbol data recording portion in which pointer symbol display data representing a display mode of a pointer symbol indicating a position on a screen of the display device are prerecorded;
a selection symbol data recording portion in which selection symbol display data representing a display mode of selection symbols that are displayed in the display device and respectively represent a plurality of functions are prerecorded;
a pointer symbol display portion for displaying the pointer symbol such that a display position of the pointer symbol is moved by an input from the input device based on the pointer symbol display data;
a selection symbol display portion for displaying the selection symbols in such a manner as to be selectable by an input from the input device based on the selection symbol display data;
a function executing portion for executing any of the plurality of functions that are realized by an operation using information representing the position indicated by the pointer symbol;
a function selecting portion for detecting that any of the plurality of functions represented by the selection symbols is selected by the input from the input device and changing the function to be executed by the function executing portion into the selected function;
a selection symbol control portion for clearing a display of the selection symbol representing the selected function when the function selecting portion changes the function to be executed by the function executing portion into the selected function; and
a pointer symbol control portion for changing the display mode of the pointer symbol according to the selected function when the function selecting portion changes the function to be executed by the function executing portion into the selected function.

2. The information processing apparatus according to claim 1, wherein the function selecting portion detects an input of deselecting the selected function from the input device and changes the function to be executed by the function executing portion from the selected function to a function before the selection, and
when the function selecting portion changes the function to be executed by the function executing portion into the function before the selection, the selection symbol control portion displays the selection symbol representing the selected function near a position of the pointer symbol at a time of the change.

3. The information processing apparatus according to claim 1, wherein the function selecting portion detects an input of deselecting the selected function from the input device and changes the function to be executed by the function executing portion from the selected function to a function before the selection, and
when the function selecting portion changes the function to be executed by the function executing portion into the function before the selection, the selection symbol control portion displays the selection symbol representing the selected function in a predetermined selection symbol display region.

4. The information processing apparatus according to claim 3, wherein the function selecting portion detects the input of deselecting the selected function from the input device and changes the function to be executed by the function executing portion from the selected function to the function before the selection, and
when the function selecting portion changes the function to be executed by the function executing portion into the function before the selection, the selection symbol control portion displays the selection symbol representing the selected function at a position closest to a position of the pointer symbol at a time of the change in the selection symbol display region.

5. The information processing apparatus according to claim 1, wherein the function selecting portion detects an input of deselecting the selected function from the input device and changes the function to be executed by the function executing portion from the selected function to the function before the selection, and
when the function selecting portion changes the function to be executed by the function executing portion from the selected function to the function before the selection, the pointer symbol control portion changes the display mode of the pointer symbol according to the function before the selection.

6. The information processing apparatus according to claim 1, wherein when the function selecting portion changes the function to be executed by the function executing portion, the selection symbol control portion displays the selection symbol representing the function before the change near a position of the pointer symbol at a time of the change.

7. The information processing apparatus according to claim 1, wherein when the function selecting portion changes the function to be executed by the function executing portion, the selection symbol control portion displays the selection symbol representing the function before the change in a predetermined selection symbol display region.

8. The information processing apparatus according to claim 7, wherein when the function selecting portion changes the function to be executed by the function executing portion, the selection symbol control portion displays the selection symbol representing the function before the change at a position closest to the position of the pointer symbol at a time of the change in the selection symbol display region.

9. The information processing apparatus according to claim 1, wherein when the function selecting portion changes the function to be executed by the function executing portion, the pointer symbol control portion changes the display mode of the pointer symbol into a display mode that is the same as or similar to the display mode of the selection symbol representing the function after the change.

10. A recording medium storing a program allowing a computer connected with a display device and an input device to execute:
a pointer symbol display operation of reading pointer symbol display data representing a display mode of a pointer symbol indicating a position on a screen of the display device from a pointer symbol data recording portion in which the pointer symbol display data are prerecorded, displaying the pointer symbol and moving a display position of the pointer symbol by an input from the input device;
a selection symbol display operation of reading selection symbol display data representing a display mode of selection symbols that are displayed in the display device and respectively represent a plurality of functions from a selection symbol data recording portion in which the selection symbol display data are prerecorded and displaying the selection symbols in such a manner as to be selectable by an input from the input device;
a function executing operation of executing any of the plurality of functions that are realized by an operation using information representing the position indicated by the pointer symbol;
a function selecting operation of detecting that any of the plurality of functions represented by the selection symbols is selected by the input from the input device and changing the function to be executed in the function executing operation into the selected function;
a selection symbol control operation of clearing a display of the selection symbol representing the selected function when the function to be executed in the function executing operation is changed into the selected function in the function selecting operation; and
a pointer symbol control operation of changing the display mode of the pointer symbol according to the selected function when the function to be executed in the function executing operation is changed into the selected function in the function selecting operation.

11. The recording medium storing a program according to claim 10, further allowing a computer to execute
as the function selecting operation, an operation of detecting an input of deselecting the selected function from the input device and changing the function to be executed in the function executing operation from the selected function to a function before the selection, and
as the selection symbol control operation, an operation of displaying the selection symbol representing the selected function near a position of the pointer symbol at a time of the change when the function to be executed in the function executing operation is changed into the function before the selection in the function selecting operation.

12. The recording medium storing a program according to claim 10, allowing a computer to execute
as the function selecting operation, an operation of detecting an input of deselecting the selected function from the input device and changing the function to be executed in the function executing operation from the selected function to a function before the selection, and
as the selection symbol control operation, an operation of displaying the selection symbol representing the selected function in a predetermined selection symbol display region when the function to be executed in the function executing operation is changed into the function before the selection in the function selecting operation.

13. The recording medium storing a program according to claim 12, allowing a computer to execute
as the function selecting operation, the operation of detecting the input of deselecting the selected function from the input device and changing the function to be executed in the function executing operation from the selected function to the function before the selection, and
as the selection symbol control operation, an operation of displaying the selection symbol representing the selected function at a position closest to the position of the pointer symbol at a time of the change in the selection symbol display region when the function to be executed in the function executing operation is changed into the function before the selection in the function selecting operation.

14. The recording medium storing a program according to claim 10, allowing a computer to execute
as the function selecting operation, an operation of detecting an input of deselecting the selected function from the input device and changing the function to be executed in the function executing operation from the selected function to the function before the selection, and
as the pointer symbol control operation, an operation of changing the display mode of the pointer symbol according to the function before the selection when the function to be executed in the function executing operation is changed from the selected function to the function before the selection in the function selecting operation.

15. The recording medium storing a program according to claim 10, allowing a computer to execute, as the selection symbol control operation, an operation of displaying the selection symbol representing the function before the change near a position of the pointer symbol at a time of the change when the function to be executed in the function executing operation is changed in the function selecting operation.

16. The recording medium storing a program according to claim 10, allowing a computer to execute, as the selection symbol control operation, an operation of displaying the selection symbol representing the function before the change in a predetermined selection symbol display region when the function to be executed in the function executing operation is changed in the function selecting operation.

17. The recording medium storing a program according to claim 16, allowing a computer to execute, as the selection symbol control operation, an operation of displaying the selection symbol representing the function before the change at a position closest to the position of the pointer symbol at a time of the change in the selection symbol display region when the function to be executed in the function executing operation is changed in the function selecting operation.

18. The recording medium storing a program according to claim 10, allowing a computer to execute, as the pointer symbol control operation, an operation of changing the display mode of the pointer symbol into a display mode that is the same as or similar to the display mode of the selection symbol representing the function after the change when the function to be executed in the function executing operation is changed in the function selecting operation.
